(19) United States
(12) Patent Application Publication
(10) Pub. No.: US 2005/0093391 A1
(43) Pub. Date: May 5, 2005

(54) Sleeveless permanent magnet rotor construction

(76) Inventors: Patrick T. McMullen, Long Beach, CA (US); Co Si Huynh, Brea, CA (US); Eric J. Blumber, Los Angeles, CA (US)

Correspondence Address: Irving Keschner, Suite 1150, 21515 Hawthorne Boulevard, Torrance, CA, 90503, US

(21) Appl. No.: 10/698,890

(22) Filed: Nov. 3, 2003

(51) Int. Cl. H02K 21/12

(52) U.S. Cl. 310/156.55; 310/156.22

(57) ABSTRACT

Method and apparatus for containing and protecting the magnets of a permanent magnet rotor spinning at high speeds without the use of a sleeve and is applicable to all permanent magnet rotors with two or more poles. Magnetic pole pieces are used to mechanically retain the magnets as well as provide a low reluctance path for the magnetic field to travel. The pole pieces and magnets are oriented radially on a hub made of a non-magnetic material such that the flux path of the magnets to the rotor poles is not shorted through the hub or shaft. The rotor poles have a taper angle and are secured to the rotor hub; the pole taper angle trapping the magnets, which have a matching taper angle. End cap pieces are provided to retain the rotor poles and the permanent magnets as an integral magnets/poles subassembly for use in a motor or generator.

### BACKGROUND OF THE INVENTION

1. Field of the Invention

The present invention relates to rotor constructions for permanent magnet motors and generators.

2. Description of the Prior Art

Conventional permanent magnet (PM) rotor designs for PM motors and generators utilize sleeves to contain the magnets when the rotor spins at high speeds. The sleeve also protects the magnet from damage during transport before the motor has been assembled. Sleeving, however, is an expensive as well as time-consuming process. Specifically, the sleeve inner diameter and the rotor outer diameter must first be ground to a precision dimension to control the amount of interference. The sleeve must then be heated to a very high temperature while the rotor is cooled for the sleeve to be shrunk on to the rotor. Proper alignment as well as expensive tooling is needed to facilitate the sleeving process; because of this, sleeving carries a high risk and mistakes often lead to the rotor and sleeve being scrapped.

A rotor design that allows for magnet containment without a sleeve would not only save time and money, but also minimize the risk involved with assembling rotors during motor or generator production.

### SUMMARY OF THE INVENTION

The present invention provides a method of containing and protecting the magnets of a permanent magnet rotor spinning at high speeds without the use of a sleeve and is applicable to permanent magnet rotors with two or more poles. Magnetic pole pieces are used to mechanically retain the magnets as well as provide a low reluctance path for the magnetic field to travel. The pole pieces and magnets are oriented radially on a hub made of a non-magnetic material such that the flux path from the magnets to the rotor poles is not shorted through the hub or shaft. The rotor poles are designed with a taper angle and mechanically held to the rotor hub or shaft. The taper angle, which is determined by the speed and size of the rotor, is used to trap the magnet, which is designed with a matching, or complementary, taper angle. End cap pieces are provided to retain the rotor poles and the permanent magnets as an integral magnets/pole subassembly for use in a motor or generator.

The present invention thus provides a rotor construction that secures the magnets to the pole pieces to form a pole piece/magnet assembly that can be attached to the rotor hub or shaft by various techniques.

### DESCRIPTION OF THE DRAWING

For a better understanding of the present invention as well as other objects and further features thereof, reference is made to the following description which is to be read in conjunction with the accompanying drawing wherein:

FIG. 1 illustrates the flux path in a permanent magnet rotor constructed in accordance with the teachings of the present invention;

FIGS. 2A-2C are perspective, sectional end and plan views, respectively, of the preferred embodiment of the present invention;

FIGS. 3A-3C are perspective, sectional end and plan views of a second embodiment of the present invention;

FIGS. 4A-4C are perspective, sectional end, plan and sectional views, respectively, of a third embodiment of the present invention and 4D; and

FIGS. 5A-5C are perspective sectional end and plan views of a fourth embodiment of the present invention;

The same reference numerals in each figure identify identical components.

### DESCRIPTION OF THE INVENTION

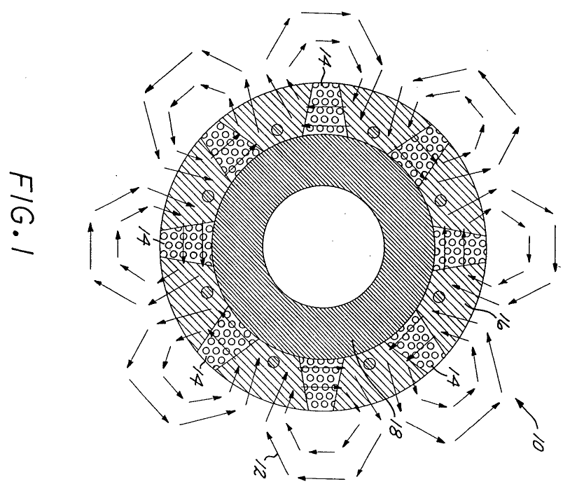

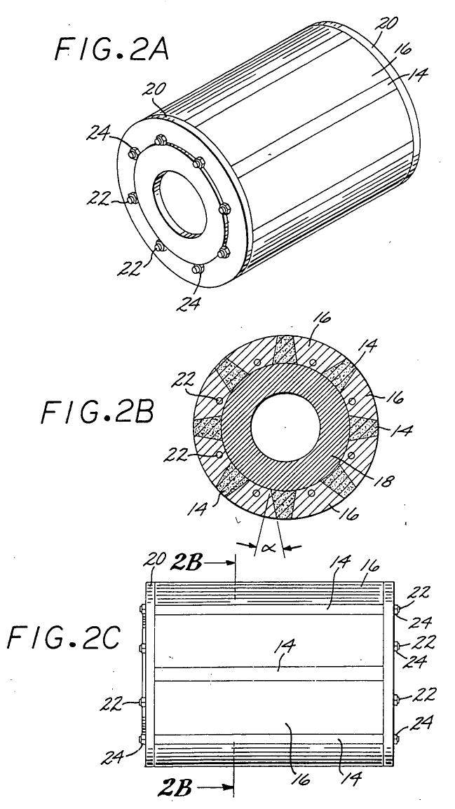

The rotor construction of the present invention is adapted for use with permanent magnet motors (or generators) with two or more poles. The flux path for an eight pole rotor configuration 10 is illustrated in FIG. 1. The flux 12 produced by the permanent magnets 14 travels through the magnetic rotor poles 16, through the air, and back to the magnet through the other adjacent magnetic rotor pole 16. The rotor hub 18 on which the magnets 14 and rotor poles 6 are mounted must be constructed using a non-magnetic material, such as aluminum, stainless steel or nickel alloys, to keep from shorting the flux path 12 between the magnets 14. The flux field 12 through the air is acted on by the stator windings (not shown) to cause the rotor to rotate in a conventional manner. The preferred embodiment of this invention is shown in FIGS. 2A-2C which, for illustrative purposes, is shown as an eight pole permanent magnet rotor.

In this configuration, two non-magnetic end caps 20 in conjunction with clamping rods 22 and nuts 24 (nuts 24 are used with both end caps 20) mechanically retain the rotor poles 16 and the permanent magnets 14 together to form an integral subassembly comprising magnets/poles (FIG. 2B is a sectional view along line A-A of FIG. 2C). The subassembly can be attached to hub 18 by various means such as bonding, interference fit, etc. Rods 22 extend along the longitudinal axis of the subassembly and for the entire length of the rotor poles 16. The function of the magnetic rotor poles 16 are to close the flux path for the magnets 14 as well as retain the magnets 14 during rotation. The taper angle α of the magnetic rotor poles 16 used to retain the magnets 14 is determined by the size and the rotating speed of the motor (or generator). A typical range of taper angles is between 5 to 15 degrees. The diameter of the clamping rods 22 is also dependent upon rotor speed. As noted hereinabove, end caps 20 are used both to protect the ends of the magnets 14 and to retain the magnetic rotor poles 16 radially, thus forming an integral subassembly. The end caps 20 are attached to the rotor poles 16 by clamping rods 22, a large clamping force not being necessary for the rotor to function properly. In a typical assembly both magnets 14 and poles 16 are fabricated separately, then assembled together in the pattern illustrated. Holes are drilled through poles 16, clamping rods 22 inserted therethrough and caps 20 positioned adjacent the end faces of the poles/magnets assembly and nuts 24 then fastened to the exposed ends of the clamping rods.

Some rotor applications require small air gaps between the rotor and the stator. In these cases, after assembly, the outer diameter of the rotor may be ground to a precision dimension before it is inserted in the motor. The magnets 14 could also be made slightly undersized, providing greater protection to the outside faces of the magnets; as a result, only the magnetic rotor poles 16 would be ground in the final grind process.

The magnetic rotor poles 16 may be constructed from either a solid piece or by stacking and bonding thin electrical steel layers called laminations to minimize rotor losses and maximize rotor response at high frequencies. Other embodiments of this sleeveless rotor construction are possible with the same resulting improvements.

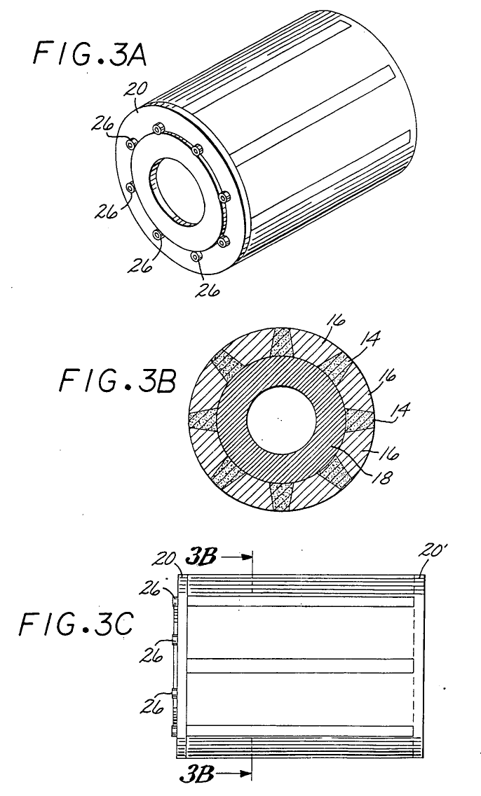

FIGS. 3A-3C illustrate a second embodiment of the rotor construction of the present invention wherein one of the non-magnetic end caps 20 (right end cap 20′ as viewed from the paper) has been fabricated such that it is an integral part of magnetic rotor poles 16 (FIG. 3B is a sectional view along line A-A of FIG. 3C). In this case, the magnetic rotor poles 16 extend from the end cap 20′ in the form of fingerlike projections or prongs in the shape illustrated. This allows for solid rotor poles; in addition, this embodiment provides for an easier assembly process since the end cap 20 is simply bolted to the rotor poles by fasteners 26 rather than utilizing separate clamping rods and nuts. The magnets 14 are positioned adjacent the rotor poles 16 and joined to hub 18 as set forth hereinabove. In an alternate version of the embodiment shown in FIGS. 3A-3C, the end cap 20 is welded directly to the poles 16.

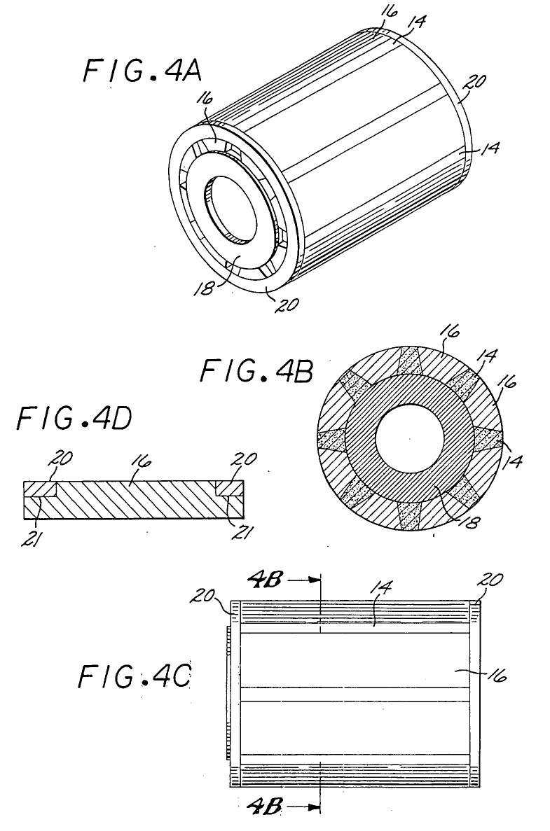

A third embodiment of the sleeveless rotor design is shown in FIGS. 4A-4D. This configuration requires no bolts or other fasteners because a radial shrink fit between the non-magnetic end caps 20 and the ends of the magnetic rotor poles 16 hold the assembly together (FIG. 4B is a sectional view along line A-A of FIG. 4C). Two lips 21 (FIG. 4D) the depth of the end caps 20 are machined onto both ends of the rotor poles 16. This provides a surface for the inner diameter of end cap 20 to grab onto and mechanically retain the rotor poles 16, and hence the magnets 14 due to the taper angle between the magnets 14 and rotor poles 16. In this embodiment, the end caps 20 alternatively can, be made of composite fiber material which is wound directly onto the rotor poles, the shrink fit process not being required.

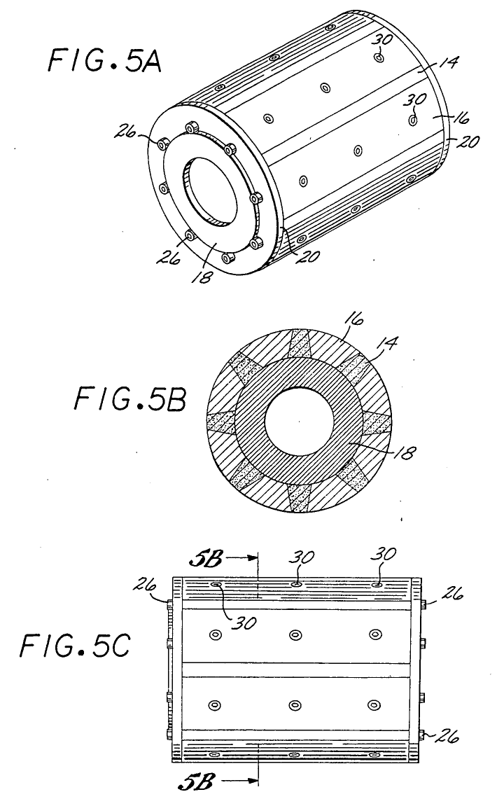

In the fourth embodiment shown in FIGS. 5A-5C, the magnetic rotor poles 16, and hence the magnets 14, are held to the hub 18 radially using countersunk bolts 30 rather than clamping rods or a lip on the rotor pole (FIG. 5B is a sectional view along line A-A of FIG. 5C). The size and number of bolts 30 used axially for each pole piece is determined by the rotating speed and size of the rotor. In this configuration, the end caps 20 are used only to protect the ends of the magnets 14 and not to retain the rotor poles 16 or magnets 14 and are secured to the assembly using fasteners 26.

The present invention thus provides a simple and economical technique for fabricating a sleeveless permanent magnet rotor construction for use in motor or generator configurations.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

1. A sleeveless permanent magnet rotor subassembly having a longitudinal axis, first and second ends and at least two poles comprising:
a cylindrically shaped elongated member having an outer surface extending in the direction of said longitudinal axis, said cylindrically shaped member being formed of a non-magnetic material;
a plurality of permanent magnets extending in the direction of said longitudinal axis, said permanent magnets having sides tapered to a predetermined angle and a bottom surface;
a plurality of rotor poles having first and second ends extending in the direction of said longitudinal axis, said rotor poles having sides tapered to a predetermined angle and a bottom surface, said permanent magnets and rotor poles being positioned adjacent each other in a manner such that the tapered sides of said rotor poles are in contact with the tapered sides of adjacent magnets, the bottom surfaces of said rotor poles being substantially in contact with the outer surface of said elongated member, the bottom surfaces of said magnets being the only portion thereof in contact with the outer surface of said elongated member; and
a first cap member positioned at said first end of said subassembly and adjacent a said first end of said rotor poles in a manner to retain the rotor poles and the permanent magnets to form an integral subassembly.

2. The subassembly of claim 1 wherein the taper angle of each rotor pole is in the range between approximately 5 to 15 degrees.

3. (canceled)

4. (canceled)

5. The subassembly of claim 1 wherein said first cap member is directly fastened to said rotor poles, said rotor poles extending in a direction towards said second subassembly end and terminating a distance therefrom.

6. The subassembly of claim 1 wherein said first cap member is shrink fitted onto said rotor poles at said first end of said subassembly and further including a second cap member positioned at said second end of said subassembly, said second cap member being shrink fitted onto said rotor poles at said subassembly second end.

7. (canceled)

8. The subassembly of claim 1 wherein a plurality of bolt members having first and second ends extend through said rotor poles and said first cap member and said second cap member, said bolt members being secured in place by fastener members.

9. (canceled)

10. (canceled)

11. (canceled)
